(19) United States
(12) Patent Application Publication
(10) Pub. No.: US 2012/0187878 A1
(43) Pub. Date: Jul. 26, 2012

(54) METHOD FOR DETECTING DETERIORATION OF PERMANENT MAGNET IN ELECTRIC MOTOR AND SYSTEM FOR THE METHOD

(75) Inventors: Hiroshi FUKASAKU, Aichi-ken (JP); Kazuki NAJIMA, Aichi-ken (JP)

(73) Assignee: KABUSHIKI KAISHA TOYOTA JIDOSHOKKI, Kariya-shi (JP)

(21) Appl. No.: 13/353,706

(22) Filed: Jan. 19, 2012

(30) Foreign Application Priority Data
Jan. 20, 2011 (JP) 2011-010262

(51) Int. Cl. H02P 6/08

(52) U.S. Cl. 318/400.21

(57) ABSTRACT

A method for detecting deterioration of a permanent magnet in an electric motor is characterized by peak current measuring steps and a determination step. In the first peak current measuring step, when the electric motor is started, a first pulsed voltage is applied to the multi-phase coils so as to generate magnetic flux directed in the same direction as generated by the permanent magnet and a first peak current is measured. In a second peak current measuring step, a second pulsed voltage is applied to the multi-phase coils so as to generate magnetic flux directed in the direction opposite to the direction in which magnetic flux is generated by the permanent magnet and a second peak current is measured. In a determination step, it is determined whether or not the permanent magnet is deteriorated based on the difference of the absolute value between the first and the second peak currents.

### BACKGROUND OF THE INVENTION

The present invention relates to a method for detecting deterioration of a permanent magnet incorporated in an electric motor in a motor compressor used for a vehicle air conditioner and also to a system for the method.

A motor compressor incorporating therein an electric motor has been used in a refrigeration cycle for a vehicle air conditioner. As a motor for such a use, a compact and high-performance electric motor having a rotor including a permanent magnet (Interior Permanent Magnet (IPM) Motor) is useful. Such a motor and a device for driving such motor are disclosed in Japanese Patent Application Publication No. 2004-7924 and Japanese Patent Application Publication No. 2006-166574.

In such type of electric motor, the characteristics of the permanent magnet in the rotor of the electric motor influences the overall characteristics of the electric motor. Thus, it is important to prevent the deterioration of any permanent magnet, and also to detect the occurrence of the deterioration at an early stage so that appropriate measures may be taken against the deterioration.

However, a technology for detecting the deterioration of a permanent magnet in a rotor of an electric motor has not been established. For example, Japanese Patent Application Publication No. 2004-7924 discloses a power generator which is operable to detect demagnetization of a permanent magnet during vehicle operation. However, an electric motor which is mounted in a vehicle and repeats stop and start operations has not been developed yet.

The present invention which has been made in light of such problems is directed to providing a method for detecting deterioration of a permanent magnet in an electric motor and a device for the method, according to which any deterioration of the permanent magnet in the electric motor which repeats start and stop operations may be easily and reliably detected.

### SUMMARY OF THE INVENTION

In accordance with the present invention, a method for detecting deterioration of a permanent magnet in an electric motor having multi-phase coils and a rotor that incorporates the permanent magnet includes first and second peak current measuring steps and a determination step. In the first peak current measuring step, a first pulsed voltage is applied to the multi-phase coils so as to generate magnetic flux directed in the same direction as the magnetic flux generated by the permanent magnet and a first peak current is measured when the electric motor is started. In the second peak current measuring step, a second pulsed voltage is applied to the multi-phase coils so as to generate magnetic flux directed in the direction opposite to the direction in which magnetic flux is generated by the permanent magnet and a second peak current is measured when the electric motor is started. In the determination step, it is determined whether or not the permanent magnet is deteriorated based on the difference of the absolute value between the first and the second peak currents.

A system for detecting deterioration of a permanent magnet in an electric motor includes an electric motor, an inverter circuit, a current sensor and a controller. The electric motor has a stator core around which multi-phase coils are wound and a rotor incorporating a permanent magnet. The inverter circuit has a plurality of switching elements converting a direct current power from a power source into an alternating current power to be supplied to the multi-phase coils. The current sensor measures a current flowing through each coil or a current from the power source. The controller controls ON/OFF operation of a plurality of switching elements and is configured to perform the method for detecting deterioration of a permanent magnet in an electric motor.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a circuit diagram showing a system for detecting deterioration of a permanent magnet in an electric motor according to a first preferred embodiment of the preset invention;

FIG. 2 is a flowchart showing a method for detecting deterioration of the permanent magnet of the system of FIG. 1;

FIG. 3 is a schematic plan view of the electric motor showing the magnetic flux of the permanent magnet in a rotor of the electric motor of FIG. 1;

FIG. 4 is a schematic plan view of the electric motor showing direction of voltage application and the state of magnetic flux during a rotor positioning step in the method of FIG. 2;

FIG. 5 is a schematic plan view of the electric motor showing direction of voltage application and the state of magnetic flux during a first peak current measuring step in the method of FIG. 2;

FIG. 6 is a schematic plan view of the electric motor showing direction of voltage application and the state of magnetic flux during a second peak current measuring step in the method of FIG. 2;

FIG. 7 is a waveform diagram showing waveforms (a) through (c) measured in the method of FIG. 2, wherein the waveform (a) shows the waveform of first and second pulsed voltages applied in the first and the second peak current measuring steps, the waveform (b) shows the waveform of the current measured in the first peak current measuring step, and the waveform (c) shows the waveform of the current measured in the second peak current measuring step;

FIG. 8 is a flowchart showing a method for detecting deterioration of a permanent magnet in a rotor of an electric motor according to a second preferred embodiment of the present invention;

FIG. 9 is a schematic plan view of the electric motor showing direction of voltage application and the state of magnetic flux during a rotor initial position detecting step in the method of FIG. 8;

FIG. 10 is a schematic plan view of the electric motor showing direction of voltage application and the state of magnetic flux during the first peak current measuring step in the method of FIG. 8;

FIG. 11 is a schematic plan view of the electric motor showing direction of voltage application and the state of magnetic flux during the second peak current measuring step in the method of FIG. 8;

FIG. 12 is a circuit diagram showing a system for detecting deterioration of a permanent magnet in an electric motor according to a third preferred embodiment of the preset invention; and

FIG. 13 is a circuit diagram showing another system for detecting deterioration of the permanent magnet of FIG. 12.

### DETAILED DESCRIPTION OF THE PREFERRED EMBODIMENTS

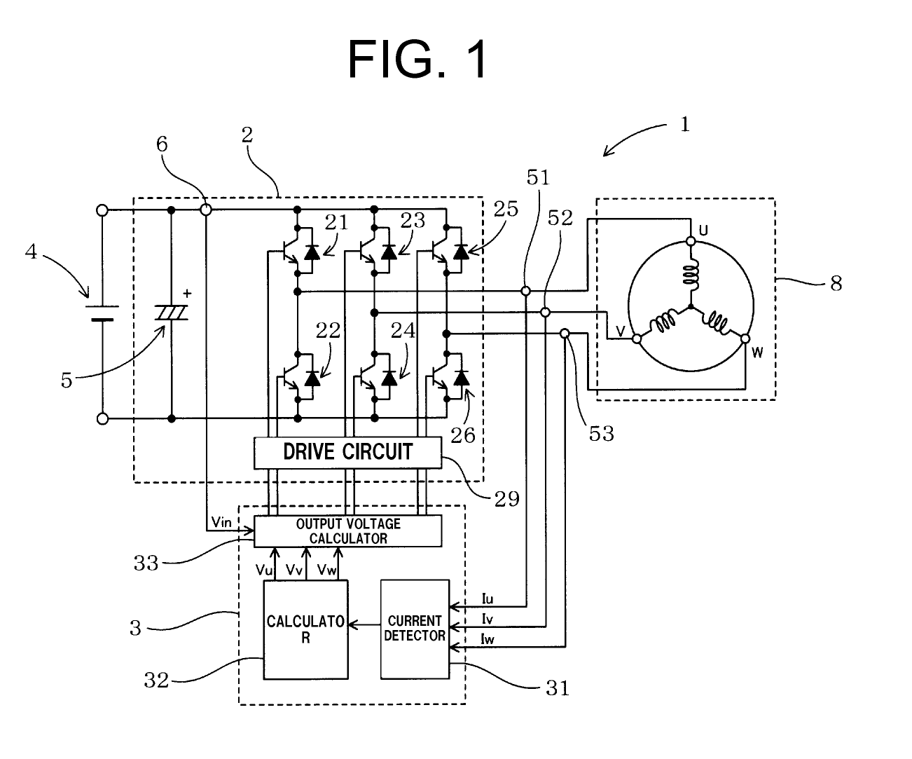

The following will describe a method for detecting deterioration of a permanent magnet of an electric motor and a system for the method according to a first preferred embodiment of the present invention with reference to FIGS. 1 through 7.

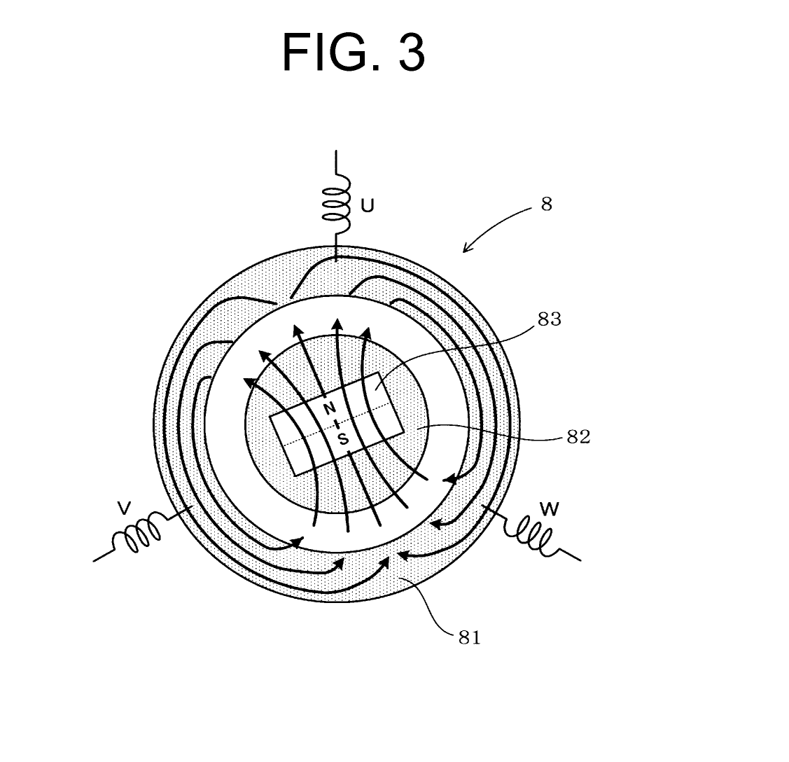

Referring to FIG. 1, a system for detecting deterioration of a permanent magnet in an electric motor is generally designated by numeral 1 and the electric motor by numeral 8, respectively. Referring to FIG. 3, the electric motor 8 has a stator core 81 around which three-phase coils serving as a multi-phase coils are wound and a rotor 82 incorporating therein a permanent magnet 83. The system 1 is used for detecting any deterioration of the permanent magnet 83 of the electric motor 8. The electric motor 8 is incorporated in a motor compressor for a vehicle air conditioner, and the system 1 is mounted in a vehicle together with the motor compressor for a vehicle air conditioner (not shown). For the sake of illustration, the electric motor 8 is schematically shown in FIG. 3, and the same is true of any other drawings.

Referring back to FIG. 1, the system 1 includes an inverter circuit 2, a controller 3 and current sensors 51 through 53. The inverter circuit 2 has a smoothing capacitor 5 and a plurality of switching elements 21 through 26 converting a direct current (DC) power from a power source 4 into an alternating current (AC) power that is to be supplied to the three-phase coils consisting of U-, V-, and W-phase coils. The controller 3 controls ON/OFF operation of the switching elements 21 through 26. The current sensors 51 through 53 detect currents Iu, Iv, Iw flowing through the U-, V, and W-phase coils, respectively. All three current sensors 51 through 53 need not necessarily be provided for the U-, V, and W-phase coils, but any two of the current sensors 51 through 53 may be provided for their corresponding two coils for detecting currents flowing through such two coils. In such a case, the current flowing through the third coil may be figured out by equation Iu+Iv+Iw=0.

The switching elements 21 through 26 of the inverter circuit 2 are composed of three pairs of switching elements. The switching elements of each pair are connected in series to each other and the three pairs of switching elements are connected in parallel to each other and also in parallel to the power source 4. A node between the series-connected switching elements 21 and 22 is connected to the input of the U-phase coil of the electric motor 8. Similarly, a node between the series-connected switching elements 23 and 24 is connected to the input of the V-phase coil of the electric motor 8, and a node between the series-connected switching elements 25 and 26 is connected to the input of the W-phase coil of the electric motor 8.

The current sensor 51 is arranged between the node between the switching elements 21 and 22 and the input of the U-phase coil of the electric motor 8 for measuring current flowing through the U-phase coil of the electric motor 8. The current sensor 52 is arranged between the node between the switching elements 23 and 24 and the input of the V-phase coil of the electric motor 8 for measuring current flowing through the V-phase coil of the electric motor 8. The current sensor 53 is arranged between the node between the switching elements 25 and 26 and the input of the W-phase coil of the electric motor 8 for measuring current flowing through the W-phase coil of the electric motor 8. The positions of the current sensors 51 through 53 are variable, as will be described in another embodiment below. A voltage sensor 6 is arranged in the inverter circuit 2 for measuring a voltage Vin of the power source 4.

The controller 3 includes a current detector 31, a calculator 32 and an output voltage calculator 33. The current detector 31 receives the information of the currents Iu, Iv, Iw measured by the current sensors 51 through 53 and transmits the information of the currents Iu, Iv, Iw to the calculator 32. Based on the currents Iu, Iv, Iw, the calculator 32 calculates the voltages Vu, Vv, Vw to be applied to respective U-, V-, and W-phase coils and then transmits the information of the calculated voltages Vu, Vv, Vw to the output voltage calculator 33. The output voltage calculator 33 adjusts the voltages Vu, Vv, Vw in view of the voltage Vin of the power source 4 detected by the voltage sensor 6 of the inverter circuit 2 and transmits drive signals to a drive circuit 29 of the inverter circuit 2. The drive circuit 29 of the inverter circuit 2 switches the switching elements 21 through 26 on and off based on the drive signals from the output voltage calculator 33.

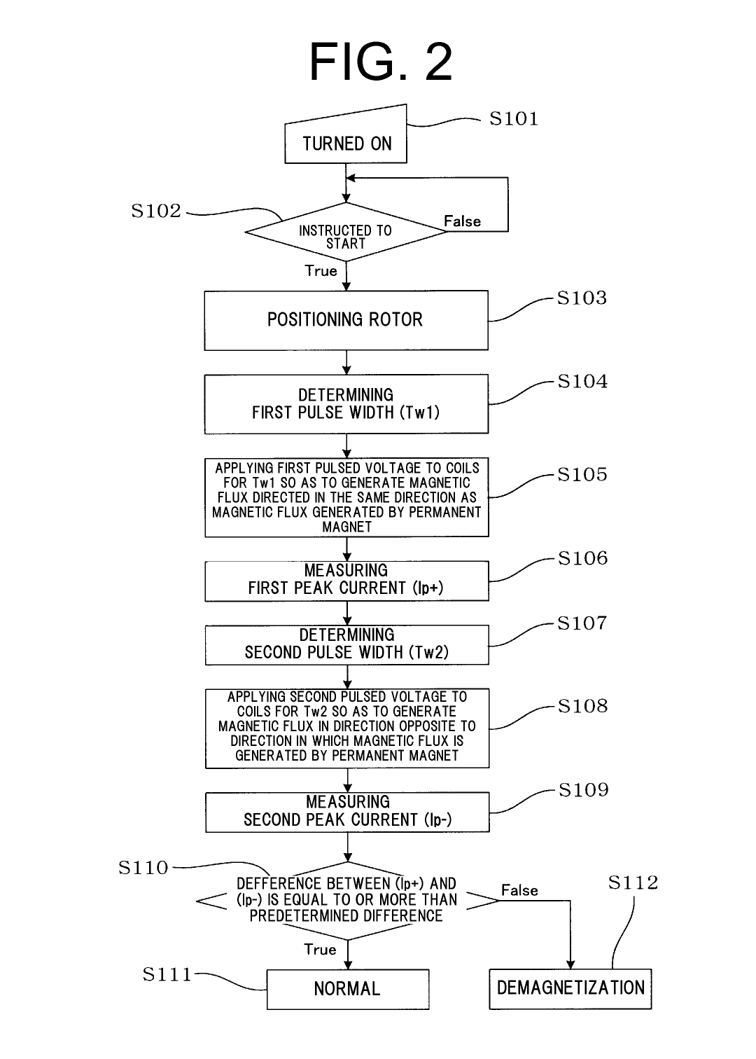

The controller 3 is configured to perform the basic function as described above and also the method for detecting any deterioration of the permanent magnet 83 in the electric motor 8. Referring to the flowchart of FIG. 2, steps S101 through S110 are performed in this order. Particularly, in step S101, the vehicle is turned on, and in the next step S102, it is determined whether or not the electric motor 8 is instructed to start. If True in step S102, or the electric motor 8 is instructed to start, the controller 3 is operated to position the rotor 82 of the electric motor 8 in step S103 or rotor positioning step. In step S104 or first pulse width determining step, the controller 3 determines a first pulse width of voltage to be applied in the following first peak current measuring step. In steps S105 and S106 or first peak current measuring step, the controller 3 is operated to measure a first peak current. In step S107 or second pulse width determining step, the controller 3 determines a second pulse width of voltage to be applied in the following second peak current measuring step. In steps S108 and S109 or second peak current measuring step, the controller 3 is operated to measure a second peak current. In step S110 or determination step, the controller 3 makes a determination.

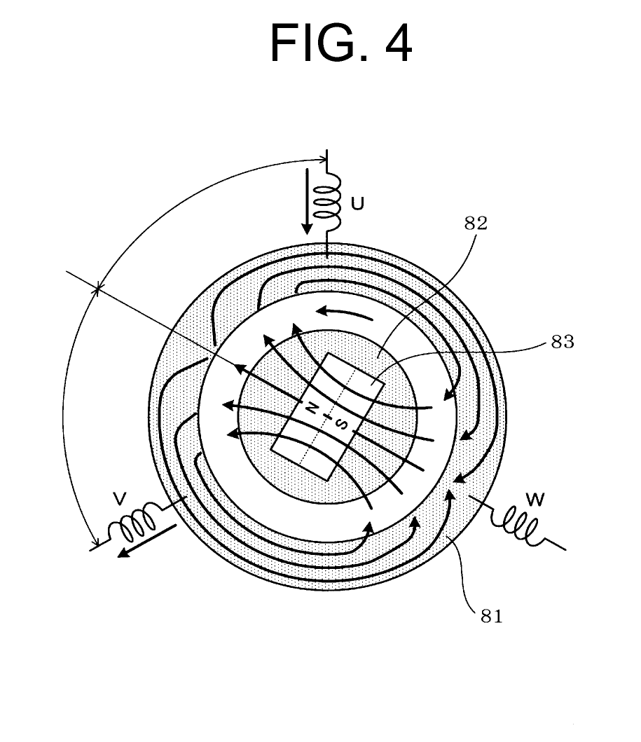

More particularly, in step S103 or rotor positioning step, the controller 3 allows DC current to flow through the three-phase coils thereby to position or set the rotor 82 incorporating therein the permanent magnet 83 at a predetermined initial angular position. In the first preferred embodiment of the present invention, the rotor 82 is rotated and set at such a position that magnetic flux generated by DC current from U-phase to V-phase corresponds to the direction of the magnetic poles of the rotor 82. In the initial state of the electric motor 8 as shown in FIG. 3, the direction of the magnetic poles of the permanent magnet 83 incorporated in the rotor 82 are not controlled and, therefore, the rotor 82 is not oriented in any specific direction. Then, DC current is flowed from U-phase to V-phase, as shown in FIG. 4. This is accomplished by turning the switching elements 21 and 24 on and turning the switching elements 22, 23, 25 and 26 off. According to the first preferred embodiment of the present invention, DC current is flowed from U-phase to V-phase for 0.5 seconds. Thus, the rotor 82 is rotated to a position where the magnetic flux of the permanent magnet 83 is aligned with the magnetic flux of the coils, and the permanent magnet 83 incorporated in the rotor 82 is positioned at a predetermined initial angular position.

In step S104 or first pulse width determining step, the voltage Vin of the power source 4 is measured as a first voltage Vin1, and a first pulse width Tw1 of a first pulsed voltage to be applied to the coils in the following first peak current measuring step is determined based on the first voltage Vin1 of the power source 4. The first pulse width Tw1 is calculated by first equation Tw1=C/Vin1, wherein C represents a predetermined constant value (voltage-time product).

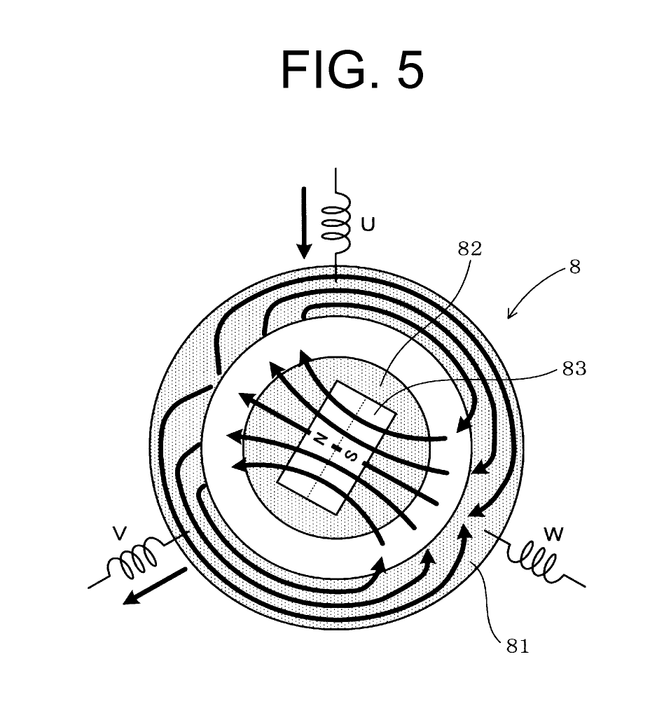

Steps S105 and S106 correspond to the first peak current measuring step. In step S105, the first pulsed voltage is applied to the coils so as to generate magnetic flux directed in substantially the same direction as the magnetic flux generated by the permanent magnet 83 of the rotor 82, as shown in FIG. 5. The first pulse width Tw1 calculated in step S104 is used as the pulse width of the first pulsed voltage for the application in step S105. The first pulsed voltage is applied to the coils such that current flows from U-phase to V-phase. Specifically, this application of the first pulsed voltage is accomplished by turning the switching elements 21 and 24 on for a time corresponding to the first pulse width Tw1, while turning the other switching elements 22, 23, 25 and 26 off. In step S106, the currents then flowing through the coils are measured by the respective current sensors 51 through 53, detection signals indicative of the measured currents transmitted to the calculator 32 through the current detector 31, and the calculator 32 calculates a first peak current Ip+.

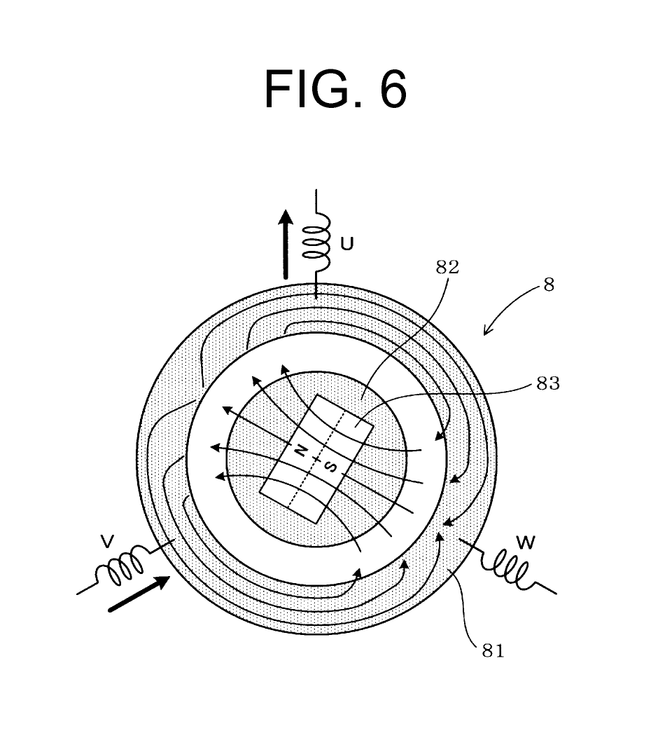

Steps S108 and S109 correspond to the second peak current measuring step. In step S108, a second pulsed voltage of a second pulse width Tw2 is applied to the coils so as to generate magnetic flux in the direction opposite to the direction in which the magnetic flux is generated by the permanent magnet 83 of the rotor 82, as shown in FIG. 6. In the previous step S107 or second pulse width determining step, the voltage Vin of the power source 4 is measured again as a second voltage Vin2, and the second pulse width Tw2 of the second pulsed voltage to be applied to the coils in the second peak current measuring step is determined based on the second voltage Vin2 of the power source 4. The second pulse width Tw2 is calculated by second equation Tw2=C/Vin2. The constant value C is the same as in the first equation for the first pulse width Tw1 in the first pulse width determining step.

The second pulsed voltage is applied to the coils in step S108 such that current flows from V-phase to U-phase that is the opposite to the direction of the current flowing in first peak current measuring step or step S105. The application of the second pulsed voltage in step S108 is accomplished by turning the switching elements 22 and 23 on for a time corresponding to the second pulse width Tw2, while turning the other switching elements 21, 24 through 26 off. In step S109, currents flowing through the coils by application of the second pulsed voltage in step S108 are measured by the current sensors 51 through 53, respectively, and the calculator 32 receives signals indicative of the measured currents through the current detector 31 and calculates the second peak current Ip−.

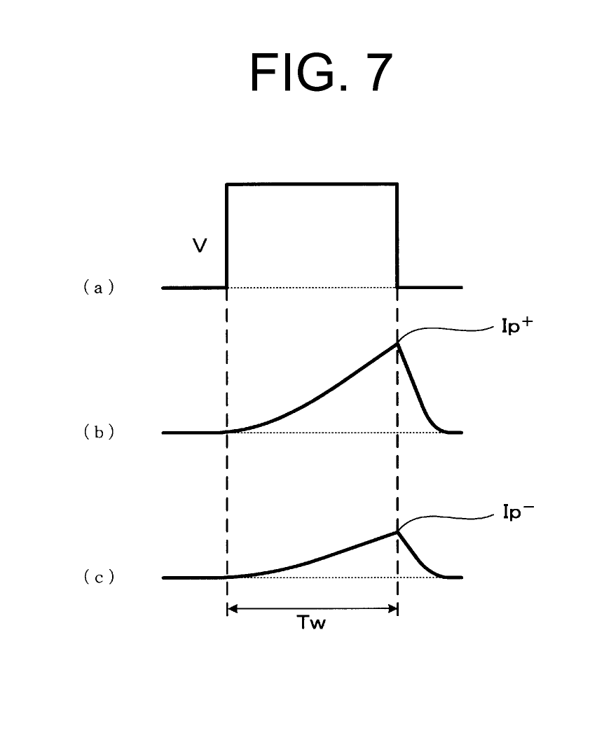

FIG. 7 is a diagram showing the relation between the first and the second peak currents Ip+ and Ip−. The waveform (a) shows the waveform of the first pulsed voltage for the application in steps S105 and S108, wherein the vertical axis represents the time and the horizontal axis represents the voltage. The waveform (b) shows the waveform of the current measured in step S106 and the first peak current Ip+ calculated in step S106, wherein the vertical axis represents the time and the horizontal axis represents the current. The waveform (c) shows the waveform of the current measured in step S109 and the second peak current Ip− calculated in step S109, wherein the vertical axis represents the time and the horizontal axis represents the current.

As is apparent from the waveforms (a) through (c) in FIG. 7, when the pulsed voltages of the same voltage-time product is applied to the coils, the first and second peak current Ip+ and Ip− vary depending on the relation between the directions of the magnetic field created by the permanent magnet 83 and the magnetic field created by the coils. The difference between the first and second peak current Ip+ and Ip− is increased as the magnetic force of the permanent magnet is increased, while the difference is decreased with a decrease of the magnetic force that is due to the deterioration of the permanent magnet. This phenomenon is utilized in performing step S110.

In step S110, the difference of the absolute value between the first and the second peak currents Ip+ and Ip− is calculated, and then it is determined whether or not the difference is equal to or more than a predetermined difference. The predetermined difference, which is varied depending on the configuration of the electric motor 8, is determined based on the results of a preliminary test. If True in step S110 or if the difference of the absolute value between the first and the second peak currents Ip+, Ip− is equal to or more than the predetermined difference, it is determined in step S111 that the permanent magnet is normal. If False in step S110 or if the difference is less than the predetermined difference, it is determined in step S112 that the permanent magnet is deteriorated and the magnetic force of the permanent magnet is decreased (demagnetization).

According to the first preferred embodiment of the present invention, steps S105 and S106 and steps S108 and S109 are performed to calculate the first and the second peak currents Ip+ and Ip−, and then the step S110 is performed based on the calculated first and the second peak currents Ip+ and Ip−. Thus, the determination whether or not the permanent magnet is deteriorated may be easily and reliably made in a short time.

More specifically, the inductance of the coils when the first pulsed voltage is applied to the coils so as to generate magnetic flux directed in the same direction as the magnetic flux generated by the permanent magnet 83 is smaller than the inductance of the coils when the second pulsed voltage is applied to the coils so as to generate the magnetic flux in the direction opposite to the direction in which the magnetic flux is generated by permanent magnet 83. Thus, the difference of the absolute value between the first and second peak currents Ip+ and Ip− flowing through the coils is made, and the difference more than a certain value is made while the permanent magnet 83 has normal magnetic characteristics.

Meanwhile, if the magnetic characteristics of the permanent magnet 83 become worse, the difference between the inductances in the first and the second peak current measuring steps becomes smaller than that when the permanent magnet 83 has normal magnetic characteristics, and the difference between the first and second peak current Ip+ and Ip− also becomes smaller than that when the permanent magnet 83 has normal magnetic characteristics.

This phenomenon is utilized in the method for detecting deterioration of the permanent magnet 83 incorporated in the electric motor 8. The determination whether or not the permanent magnet 83 is deteriorated may be easily made at least by the first and the second peak current measuring steps and the determination step.

The electric motor 8 is mounted in a motor compressor for a vehicle air conditioner (not shown). If deterioration of the permanent magnet in the electric motor progresses while the vehicle is at a stop, it is important to be informed of the deterioration before starting the vehicle. When the permanent magnet is broken due to the deterioration, magnet powder of the broken permanent magnet enters into the circuit for the vehicle air conditioner thereby to cause malfunction of the circuit. According to the first preferred embodiment of the present invention, even if the permanent magnet is broken due to the deterioration, appropriate measures against the entering of the magnet powder may be taken before the malfunction spreads throughout the circuit.

According to the method for detecting deterioration of a permanent magnet in an electric motor and the system for the method, a DC power source mounted in the vehicle is used as the power source 4. The voltage of the power source 4 may be varied depending on the condition in which the vehicle has been used and, therefore, the execution of steps S104 and S107, or the measurement of the voltage Vin of the power source 4 in steps S104 and S107, is effective for ensuring the stability of the determination in step S110.

In order to ensure the stability of the measurement of the currents, the first and the second pulsed voltages used in the first and the second peak current measuring steps need to be constant value. In order to apply the constant pulsed voltage, the voltage time product need to have a constant value. If the pulse width T of the voltage-time product is not made by one pulse of voltage, the pulsed voltage may be applied for a plurality of times so as to be the constant voltage-time product.

If a voltage V of the power source 4 for determining the pulsed voltage has a constant value, the pulse width T of the pulsed voltage may be previously set a predetermined constant value. In this case, the first and the second pulse width determining steps may be omitted. If the voltage V of the power source 4 varies in a relatively wide range, it is not preferable to set the pulse width T a predetermined constant value. Therefore, it is effective that the voltage V of the power source 4 is measured in the first and the second pulse width determining steps, and then the pulse width T of the pulsed voltage is determined based on the measured voltage V of the power source 4 and used in the first and the second peak current measuring steps.

In the electric motor 8 mounted in the motor compressor for the vehicle air conditioner, the position of the rotor 82 of the electric motor 8 is not constant when the compressor is stopped. Therefore, the execution of step S103, or the positioning the rotor 82, is also effective for ensuring the stability of the determination in step S110. The step S103 may be changed to another step as described below.

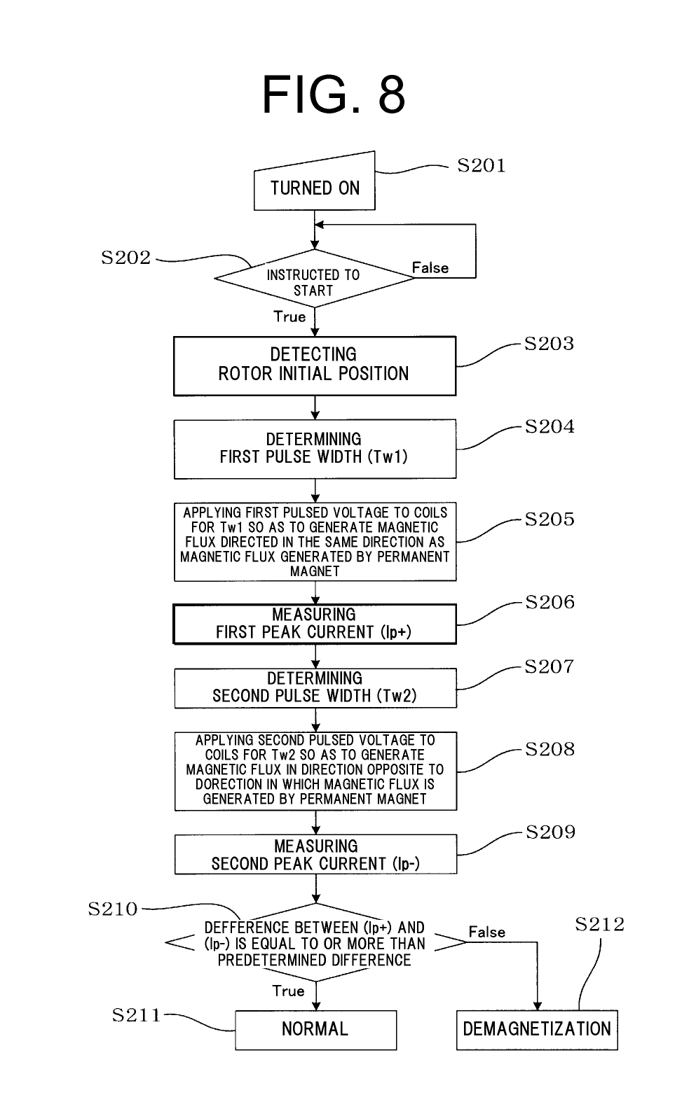

The following will describe a second preferred embodiment of the present invention with reference to FIGS. 8 through 11.

According to the second preferred embodiment, step S103 of the first preferred embodiment is changed to step S203. Referring to the flowchart of FIG. 8, according to the second preferred embodiment of the present invention, steps S201 through S212 are performed in this order. As in the first preferred embodiment, a vehicle is turned on in step S201, and it is confirmed whether or not the electric motor 8 is instructed to start in step S202. If True in step S202, the initial position of the rotor 82 is detected in step S203 or a rotor initial position detecting step just after the electric motor 8 is started. As in the first preferred embodiment, in step S204 or first pulse width determining step, the first pulse width Tw1 of the first pulsed voltage to be applied in the following first peak current measuring step is determined. In steps S205 and S206 or first peak current measuring step, the first peak current Ip+ is measured. In step S207 or second pulse width determining step, the second pulse width Tw2 of the second pulsed voltage to be applied in the following second peak current measuring step is determined. In steps S208 and S209 or second peak current measuring step, the second peak current Ip− is measured. In step S210 or determination step, determination is made. The execution of these steps is controlled by the controller 3.

In step S203, the angular position of the rotor 82 incorporating therein the permanent magnet 83 is detected. A current data table representing the relation between the currents flowing through the three-phase coils and the angular position of the rotor 82 is previously made. In step S203, the currents of the three-phase coils are measured, and the initial angular position of the rotor 82 is figured out by using the current data table. In the current data table, the position of the rotor 82 is divided into twelve different regions, and each region has an approximate equation representing the relation between the current and the angular position of the rotor 82. The rotor initial position detecting step is disclosed in the Publication No. 2006-166574.

In step S203, the currents flowing in the U-phase coil by voltage application between U-phase and V- and W-phases (+U-phase current), flowing in the V-phase coil by voltage application between V-phase and U- and W-phases (+V-phase current) and flowing in the W-phase coil by voltage application between W-phase and U- and V-phases (+W-phase current) are measured. Also, the currents flowing in the U-phase coil by voltage application between V- and W-phases and U-phase (−U-phase current), flowing in the V-phase coil by voltage application between U- and W-phases and V-phase (V-phase current) and flowing in the W-phase coil by voltage application between U- and V-phases and W-phase (−W-phase current) are measured.

Then, measured +U-phase, +V-phase and +W-phase currents are arranged in the order of the magnitude, and two regions of rotor position are selected from the current data table. The absolute values of the current of +phase having the largest current and the current of its corresponding −phase are compared. For example, when the current of +U-phase is the largest of the currents of +phase, the absolute values of +U-phase current and −U-phase current are compared. One region is selected from the selected two regions based on the comparison. The position of the rotor 82 is calculated by the approximate equation in the current data table representing the relation between the current and the angular position. Thus, the initial angular position of the rotor 82 is determined in step S203.

As in the case of the first preferred embodiment of the present invention, in step S204 or first pulse width determining step, the pulse width Tw1 of the first pulsed voltage to be applied to the coils in the following first peak current measuring step is determined.

In the second preferred embodiment of the present invention, steps S205 and S206 correspond to the first peak current measuring step. As in the case of the first preferred embodiment, the first pulsed voltage is applied to the coils so as to generate magnetic flux in the same direction as the magnetic flux generated by the permanent magnet 83 of the rotor 82. The direction of voltage application to the coils is determined based on the result of step S203, thus the direction of voltage application to the coils is variable.

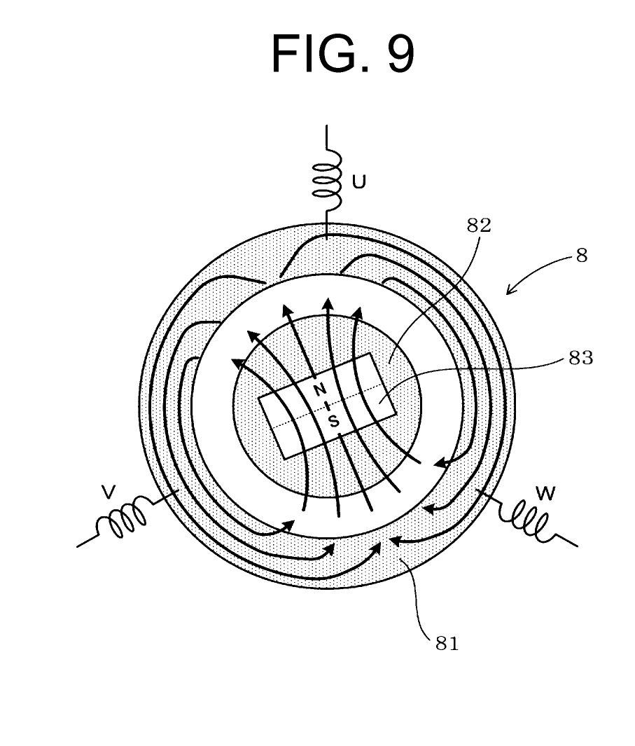

When the direction of the magnetic flux of the permanent magnet 83 depending on the initial angular position of the rotor 82 does not correspond to the direction of the magnetic flux of the coils produced simply by voltage application between any two phases, as shown in FIG. 9, the first pulsed voltage for voltage application to the phases needs to be adjusted thereby so as to align the magnetic flux of the permanent magnet to the magnetic flux of the coils.

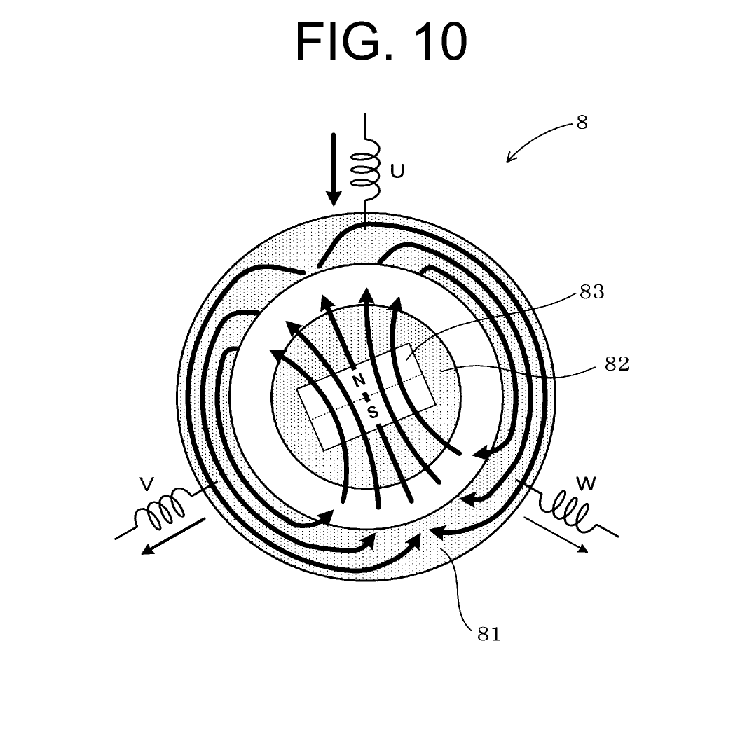

FIG. 10 shows an example of application of the first pulsed voltage, wherein the width of the arrow represents the size of the first pulse width Tw1 of the first pulsed voltage applied to the coils and the direction of the arrow represents the direction of application of the first pulsed voltage. In this example, the first pulsed voltage is applied to the U-phase coil for the time Tw1, and the time of voltage application for current flowing from U-phase to V-phase and the time of voltage application for current flowing from U-phase to W-phase are shortened. In step S205, the first pulsed voltage may be applied to the coils so as to generate the magnetic flux directed in the same direction as the magnetic flux generated by the permanent magnet 83 of the rotor 82. In step S206, the first peak current Ip+ flowing through the coils is measured.

As in step S107 in the first preferred embodiment, step S207 is performed to determine the second pulse width Tw2 of the second pulsed voltage to be applied to the coils.

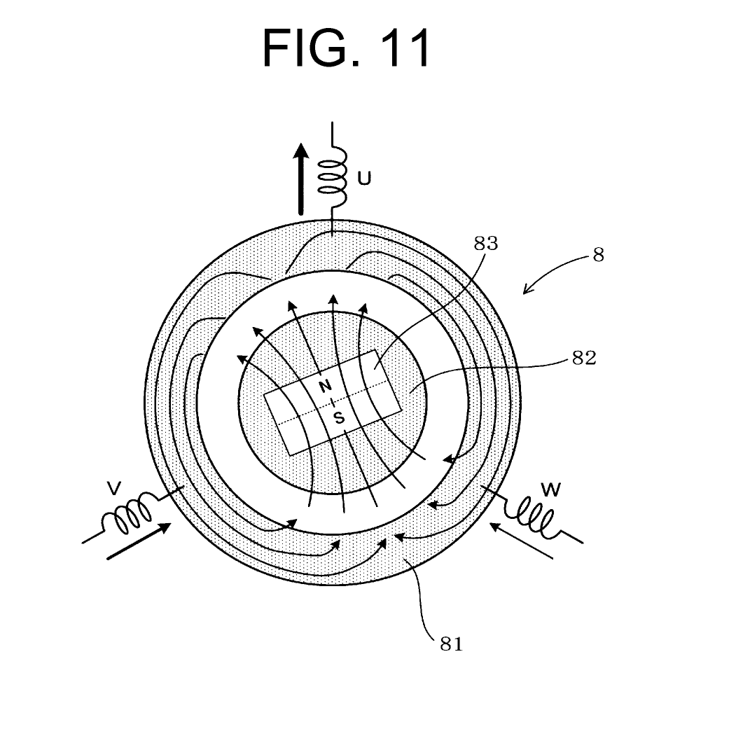

Steps S208 and S209 correspond to the second peak current measuring step. In step S208, the second pulsed voltage is applied to the coils in the direction that is opposite to the direction in which the first pulsed voltage is applied in step S205, as shown in FIG. 11, so that the magnetic flux generated by the coils is directed opposite to the magnetic flux generated by the permanent magnet 83 of the rotor 82. In step S209, the second peak current Ip− flowing through the coils is measured. Steps S210 through S212 correspond to steps S110 through S112 in the first preferred embodiment.

According to the second preferred embodiment of the present invention, step S203 is performed before steps S205, S206 and steps S208, S209, or just after the electric motor 8 is instructed to start. Step S203 may be accomplished only by electrical processing without rotating the rotor 82. Thus, step S203 is performed rapidly. Therefore, the determination whether or not the permanent magnet is deteriorated may be easily and reliably made in a shorter time. According to the second preferred embodiment, the same advantages effects as those of the first preferred embodiment can be obtained.

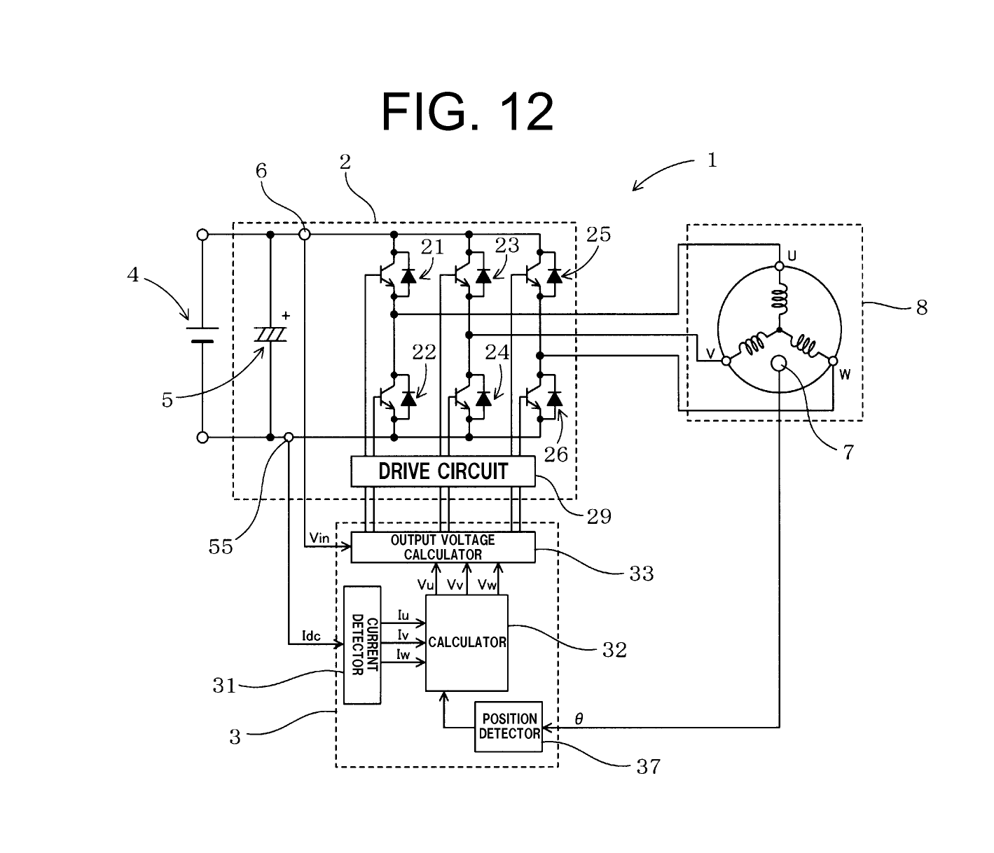

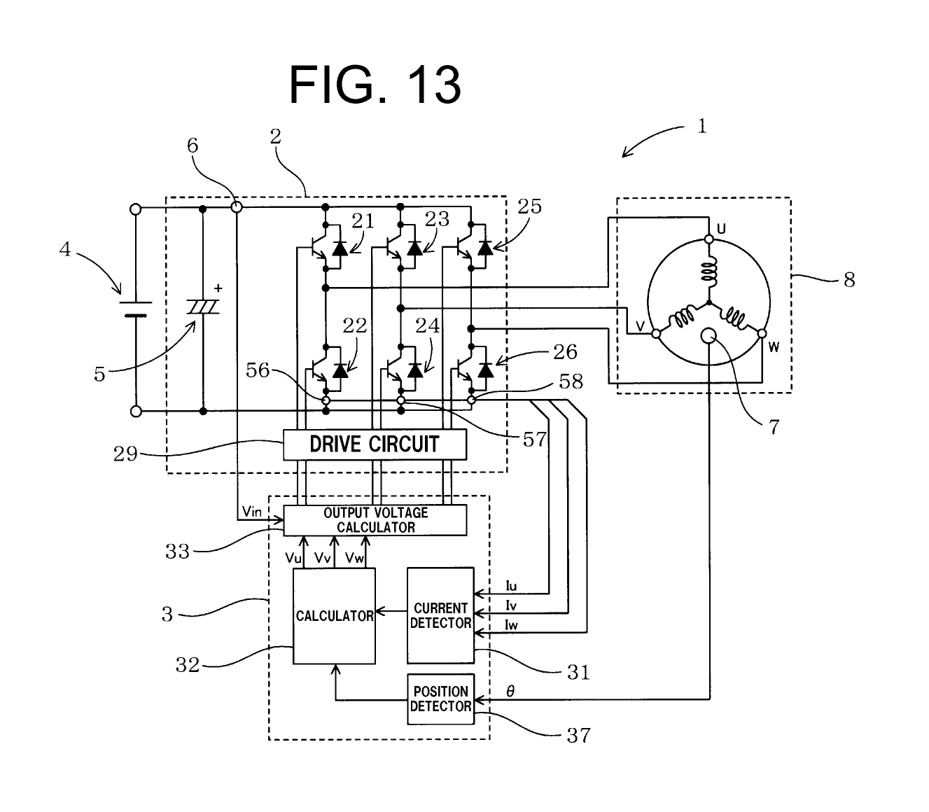

The following will describe a third preferred embodiment of the present invention with reference to FIGS. 12 and 13.

Referring to FIG. 12, a position sensor 7 is provided for directly detecting the angular position of the rotor 82 of the electric motor 8, and a position detector 37 is provided in the controller 3, thereby simplifying the process of step 203 of the second preferred embodiment. According to the third preferred embodiment of the present invention, the position of the rotor 82 may be directly determined from the angular position θ detected by the position sensor 7. In the third preferred embodiment, a resolver is used as the position sensor 7. Alternatively, any known position sensors may be employed.

In the third preferred embodiment, a current sensor 55 is disposed at a position close to the power source 4 for measuring current flowing through the three-phase coils, as shown in FIG. 12. As shown in FIG. 13, current sensors 56 through 58 connected to the source terminals of the respective switching elements may be used instead of the current sensor 55 of FIG. 12. The rest of the structure of the third preferred embodiment is substantially the same as that of the second preferred embodiment. According to the third preferred embodiment, the same advantages effects as those of the second preferred embodiment may be obtained. In the first through the third preferred embodiments, only one pulse of the pulsed voltage is applied. Alternatively, the pulsed voltage may be applied for a plurality of times depending on the relation between the pulse width of the pulsed voltage for application and the carrier frequency of the inverter circuit.

What is claimed is:

1. A method for detecting deterioration of a permanent magnet in an electric motor, the electric motor having multi-phase coils and a rotor that incorporates the permanent magnet, the method comprising:
a first peak current measuring step of applying a first pulsed voltage to the multi-phase coils so as to generate magnetic flux directed in the same direction as the magnetic flux generated by the permanent magnet and measuring a first peak current when the electric motor is started;
a second peak current measuring step of applying a second pulsed voltage to the multi-phase coils so as to generate magnetic flux directed in the direction opposite to the direction in which magnetic flux is generated by the permanent magnet and measuring a second peak current when the electric motor is started; and
a determination step of determining whether or not the permanent magnet is deteriorated based on the difference of the absolute value between the first peak current and the second peak current.

2. The method according to claim 1, wherein the method further includes, before the first peak current measuring step, a first pulse width determining step of measuring a first voltage of a power source and determining based on the first voltage a first pulse width of the first pulsed voltage to be applied to the multi-phase coils in the first peak current measuring step, and
the method further includes, before the second peak current measuring step, a second pulse width determining step of measuring a second voltage of the power source and determining based on the second voltage a second pulse width of the second pulsed voltage to be applied to the multi-phase coils in the second peak current measuring step.

3. The method according to claim 1, wherein the method further includes a rotor positioning step of flowing current through the multi-phase coils to position the rotor at a predetermined initial angular position just after the electric motor is instructed to start.

4. The method according to claim 1, wherein the method further includes a rotor initial position detecting step of detecting an angular position of the rotor just after the electric motor is instructed to start.

5. The method according to claim 1, wherein the electric motor is incorporated in a motor compressor for a vehicle air conditioner.

6. A system for detecting deterioration of a permanent magnet in an electric motor comprising:
an electric motor that has a stator core around which multi-phase coils are wound and a rotor incorporating a permanent magnet;
an inverter circuit that has a plurality of switching elements converting a direct current power from a power source into an alternating current power to be supplied to the multi-phase coils;
a current sensor that measures a current flowing through each coil or a current from the power source; and
a controller that controls ON/OFF operation of a plurality of switching elements, the controller is configured to perform the method according to claim 1.

7. The system according to claim 6, wherein the method further includes, before the first peak current measuring step, a first pulse width determining step of measuring a first voltage of a power source and determining based on the first voltage a first pulse width of the first pulsed voltage to be applied to the multi-phase coils in the first peak current measuring step, and
the method further includes, before the second peak current measuring step, a second pulse width determining step of measuring a second voltage of the power source and determining based on the second voltage a second pulse width of the second pulsed voltage to be applied to the multi-phase coils in the second peak current measuring step.

8. The system according to claim 6, wherein the method further includes a rotor positioning step of flowing current through the multi-phase coils to position the rotor at a predetermined initial angular position just after the electric motor is instructed to start.

9. The system according to claim 6, wherein the method further includes a rotor initial position detecting step of detecting an angular position of the rotor just after the electric motor is instructed to start.

10. The system according to claim 6, wherein the electric motor is incorporated in a motor compressor for a vehicle air conditioner.
